(19) United States
(12) Patent Application Publication
(10) Pub. No.: US 2012/0208957 A1
(43) Pub. Date: Aug. 16, 2012

(54) TWO-PART FOAMABLE ADHESIVE WITH RENEWABLE POLYOL

(75) Inventors: Nicholas John Berard, Novi, MI (US); Michael Lewis Kerman, Romeo, MI (US); Wayne Mazorow, Orange Village, OH (US)

(73) Assignee: ADCO PRODUCTS, INC., MICHIGAN CENTER, MI (US)

(21) Appl. No.: 13/380,795

(22) PCT Filed: Jul. 1, 2010
(86) PCT No.: PCT/US10/40742

§ 371 Date: Dec. 23, 2011

Related U.S. Application Data
(60) Provisional application No. 61/222,696, filed on Jul. 2, 2009.

(51) Int. Cl. C09J 175/04; C08K 5/41

(52) U.S. Cl. 524/745; 524/839

(57) ABSTRACT

An adhesive composition for use on a roofing substrate includes two components that are mixed prior to application on the roofing substrate. The first component includes renewable polyols, catalysts, fumed silicas, water, and surfactants. The renewable polyols are selected from any non-petroleum based polyol that is derived from a renewable source. The second component includes isocyanates, polyols, surfactants, fumed silicas, and a catalyst.

### FIELD

The present invention relates to a two-part foamable adhesive for use on roofing substrates, and more particularly to a two-part foamable adhesive having renewable polyol for use on roofing substrates.

### BACKGROUND

In many roofing applications, for example in large, flat commercial roof decks, a roofing membrane is used to seal and protect the roof deck from environmental weather conditions. The roofing membrane may be made of various materials, such as polymeric materials including EPDM (ethylene propylene diene M-rubber) or TPO (thermoplastic polyolefin). The roofing membrane is adhered overtop insulation boards or panels. The insulation boards are typically secured to the roofing substrate or roof deck via an adhesive composition. A conventional adhesive composition used to adhere the insulation boards to the roof deck includes polyurethane. The polyurethane adhesives are oftentimes applied directly onto the roof deck and the insulation boards are then laid onto the roof deck surface. Conventional polyurethane adhesives oftentimes include two separate parts that are mixed by an applicator just prior to being applied onto the surface of the roof deck. The two parts include an isocyanate blend and a polyol blend. Upon mixing, the isocyanate blend reacts or crosslinks with the polyol blend to form the polyurethane adhesive.

There is room in the art for an adhesive composition in roofing applications that exhibits favorable properties, such as sufficient adhesive strength, shelf life, cure time, and tack, that also includes a renewable or environmentally favorable polyol.

### SUMMARY

The present invention provides an adhesive composition for use on a roofing substrate. The adhesive composition includes two components that are mixed prior to application on the roofing substrate. The first component includes a renewable polyol, catalysts, fumed silica, water and surfactants. The renewable polyol is selected from any non-petroleum based polyol that is derived from a renewable source. The blend of renewable polyol, catalysts, fumed silica and surfactants are made shelf stable by the incorporation of a catalyst blend that includes SLES and amines. Shelf stability means that the blend does not separate into distinct layers and reacts the same or very nearly the same as when it was initially blended even after 6 months storage. The second component includes isocyanate, and may also include a polyol, a surfactant, fumed silica, and a catalyst.

In one aspect of the present invention, the renewable polyol is a soybean oil based polyol.

In another aspect of the present invention, the renewable polyol is based upon the hydroxylation of a fatty acid based triglyceride.

In another aspect of the present invention, the renewable polyol is a Castor oil based polyol

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

A two-part adhesive composition according to the principles of the present invention is provided for securing a first component to a roofing substrate. In the example provided, the first component is an insulation board and the roofing substrate is a concrete, light weight concrete, wood, gypsum, wood fiber or steel roof deck. However, it should be appreciated that other components and other roofing substrates may employ the two-part adhesive composition without departing from the scope of the present invention. The two-part adhesive composition is generally formed by combining two separate compositions or blends prior to application on the roofing substrate. The two parts include a “B Side” or resin side and an “ A Side” or prepolymer side. Each of the sides are packaged separately and are mixed by an applicator prior to applying on the roofing substrate.

The B Side blend generally includes a renewable polyol, catalysts, fumed silica, water and a surfactant. The renewable polyol is selected from any non-petroleum based polyol that is derived from a renewable source, i.e., is a natural polyol. In a preferred example of the present invention, the renewable polyol is a soybean oil based polyol. Alternatively, the renewable polyol includes Castor oil based polyols and polyols based upon the hydroxolization of a fatty acid based triglyceride. Exemplary renewable polyols suitable with the composition of the present invention are commercially available from Urethane Soy Systems Company under the designation SOYOL including SOYOL R2-052-G and R2-052-C. Other exemplary renewable polyols commercially available from the G. R. O'Shea Company under the designation POLYCIN. Further examples are available under the designation Agrol 2.0 and Agrol 3.6 from BioBased Technologies, LLC and BiOH 210 and 600 from Cargill. Chemical derivatives and combinations of renewable polyols may also be employed in the composition without departing from the scope of the present invention. The renewable polyol comprises from about 5% to about 95% by weight of the B Side of the composition. In addition, the B side composition may include a nonrenewable polyol in addition to the renewable polyol. An exemplary nonrenewable polyol is ARCOL PPG 2000 commercially available from Bayer MaterialScience. The nonrenewable polyol comprises from about 0% to about 70% by weight of the composition.

The catalysts are selected from any amine catalysts in order to achieve the desired reaction profile between the resin and isocyanate components. In a preferred example of the present invention, the catalysts used in the B Side blend include a catalyst commercially available from Air Products and Chemicals under the designation DABCO 33LV, and Dimethylethanolamine (DMEA) commercially available from numerous manufacturers. While DMEA is used in this example, it should be clear to anyone skilled in the art that numerous other amines and their derivatives could be used in this application. In addition, chemical derivatives and combinations of catalysts may also be employed in the composition without departing from the scope of the present invention. The Dabco 33LV catalyst comprises from about 0% to about 3% by weight of the B-Side of the composition and the DMEA comprises from about 0% to about 4% by weight of the B Side of the composition.

The fumed silica is used as a thickening agent and it should be appreciated that other rheology modifiers may be selected other than fumed silica without departing from the scope of the present invention. Fumed silica suitable for use with the present invention is commercially available from Cabot under the name CAB-O-SIL TS-720 or commercially available from Wacker Chemie AG under the name HDK H18. Chemical derivatives and combinations of rheology modifiers may also be employed in the composition without departing from the scope of the present invention. The fumed silica comprises from about 0% to about 3.0% by weight of the B Side of the composition.

The surfactant or compatabilizer is preferably a 30 mole ethylene oxide adduct of sodium lauryl sulfate. Depending on the renewable polyol used, the sodium lauryl ether sulfate molecule should contain 30 moles of ethylene oxide to prevent separation. However, when using, for example POLYCIN GR 35 or SOYOL R2-052-C, less than 30 moles of ethylene oxide may be employed. It should be appreciated that greater than 30 moles of ethylene oxide in sodium lauryl ether sulfate may be employed without departing from the scope of the present invention. Exemplary surfactants suitable with the composition of the present invention are commercially available from Cognis under the designation DISPONIL FES-77 and from the Stepan Company under the designation Polystep B-19. Chemical derivatives and combinations of surfactants or compatabilizers may also be employed in the composition without departing from the scope of the present invention. The surfactant or compatabilizer comprises from about 0.1% to about 10% by weight of the B Side of the composition.

The water comprises from about 0.5% to about 10% by weight of the B Side of the composition, more preferably from about 0.7% to about 3.8% by weight of the B Side of the composition, and in a preferred embodiment from about 1% to about 3% by weight of the B Side of the composition.

The blend of renewable polyol, catalysts, fumed silica and surfactants are made shelf stable by the incorporation of the catalyst blend that includes the SLES and amines. Shelf stability means that the blend does not separate into distinct layers and reacts the same or very nearly the same as when it was initially blended even after 6 months storage.

The A Side component includes isocyanate, and may include polyols, surfactants, fumed silicas, and a catalyst. The isocyanate includes compounds having at least one isocyanate functionality group of NCO. One exemplary isocyanate suitable with the composition of the present invention includes is commercially available from BASF under the designation LUPRANATE M10. Another exemplary isocyanate suitable with the present invention includes polymeric diphenylmethane diisocyanate commercially available from Bayer MaterialScience under the designation MONDUR MRS-5 and MONDUR MR. Chemical derivatives and combinations of isocyanates may also be employed in the composition without departing from the scope of the present invention. The isocyanate comprises from about 30% to about 100% by weight of the A Side of the composition.

The polyol includes any compound conventionally used in the production of polyurethanes and having at least one isocyanate-reactive functionality. One exemplary polyol suitable with the composition of the present invention includes polypropylene glycol commercially available from BASF under the designation PLURACOL P2010. Another exemplary polypropylene glycol suitable with the present invention is commercially available from Bayer MaterialScience under the designation ARCOL PPG-2000. Chemical derivatives and combinations of polyol may also be employed in the composition without departing from the scope of the present invention. The polyol comprises from about 0% to about 60% by weight of the A Side of the composition.

The surfactant is preferably a silicone surfactant used to stabilize the foam of the adhesive composition. Various surfactants may be employed without departing from the scope of the present invention. An exemplary surfactant suitable with the composition of the present invention is commercially available from Air Products and Chemicals under the designation DABCO DC-193. Chemical derivatives and combinations of surfactants may also be employed in the composition without departing from the scope of the present invention. The surfactant comprises from about 0% to about 2% by weight of the A Side of the composition.

The fumed silica is used to aid in the dispensing of the A side composition from the applicator. It should be appreciated that other rheology modifiers may be selected other than fumed silica without departing from the scope of the present invention. Fumed silica suitable for use with the present invention is commercially available from Cabot under the name CAB-O-SIL TS-720 or commercially available from Wacker Chemie AG under the name HDK H18. Chemical derivatives and combinations of rheology modifiers may also be employed in the composition without departing from the scope of the present invention. The fumed silica comprises from about 0% to about 4% by weight of the A Side of the composition.

The catalyst employed includes any metal based polyurethane catalyst employed to expedite the reaction of the polyol with the isocyanate. An example of a catalyst includes Cotin 227. Chemical derivatives and combinations of metal based polyurethane catalysts and certain amine based catalysts may also be employed in the composition without departing from the scope of the present invention. The catalyst comprises from about 0% to about 0.5% by weight of the A Side of the composition.

In order that the invention may be more readily understood, reference is made to the following examples which are intended to illustrate various embodiments of the two-part adhesive composition of the present invention, but not limit the scope thereof:

“B SIDE” RESIN COMPOSITION

| | EXEMPLARY | PREFERRED | MOST PREFERRED | EXAMPLE 1 |
|---|---|---|---|---|
| | TRADE NAME | RANGE (PERCENT | RANGE (PERCENT | (PERCENT |
| COMPONENT | OR DESIGNATION | BY WEIGHT) | BY WEIGHT) | BY WEIGHT) |
| Renewable Polyol | Soyol R2-052-G | 28-95% | 90-95% | 93.02% |
| Catalyst | Dabco 33LV | 0-4% | 0-2% | 0.47% |
| Catalyst | DMEA | 0-4% | 0-2% | 1.86% |
| Fumed Silica | HDK H18 | 0-3.5% | 0-2% | 1.86% |
| Surfactant | Polystep B-19 | 1-5% | 1-4% | 2.79% |
| Nonrenewable Polyol | PPG 2000 | 0-70% | 0-10% | 0% |
| Water Content of Blend | | 0.7-10% | 0.7-3% | 1.95% |
| | EXEMPLARY | PREFERRED | MOST PREFERRED | EXAMPLE 2 |
| | TRADE NAME | RANGE (PERCENT | RANGE (PERCENT | (PERCENT |
| COMPONENT | OR DESIGNATION | BY WEIGHT) | BY WEIGHT) | BY WEIGHT) |
| Renewable Polyol | Soyol R2-052-C | 50-80% | 50-80% | 69.78% |
| Renewable Polyol | Polycin GR 35 | 20-50% | 20-50% | 23.24% |
| Catalyst | Dabco 33LV | 0-4% | 0-2% | 0.47% |
| Catalyst | DMEA | 0-4% | 0-2% | 1.86% |
| Fumed Silica | HDK H18 | 0-3.5% | 0-2% | 1.86% |
| Surfactant | Polystep B-19 | 1-5% | 1-4% | 2.79% |
| Water Content of Blend | | 0.7-10% | 0.7-3% | 1.95% |
| | EXEMPLARY | PREFERRED | MOST PREFERRED | EXAMPLE 3 |
| | TRADE NAME | RANGE (PERCENT | RANGE (PERCENT | (PERCENT |
| COMPONENT | OR DESIGNATION | BY WEIGHT) | BY WEIGHT) | BY WEIGHT) |
| Renewable Polyol | Polycin GR 35 | 90-95% | 90-95% | 94.07% |
| Catalyst | Dabco R-8020 | 1-4% | 1-3% | 1.88% |
| Surfactant | Surfactol 365 | 0-3% | 0-3% | 0.94% |
| Water Content of Blend | | 0.7-10% | 0.7-3% | 2.16% |
| Surfactant | Polystep B-19 | 1-5% | 1-4% | 3.09% |

“A SIDE” PRE-POLYMER COMPOSITION

| | EXEMPLARY | PREFERRED | MOST PREFERRED | EXAMPLE 1 |
|---|---|---|---|---|
| | TRADE NAME | RANGE (PERCENT | RANGE (PERCENT | (PERCENT |
| COMPONENT | OR DESIGNATION | BY WEIGHT) | BY WEIGHT) | BY WEIGHT) |
| Isocyanate | Lupranate M-10 | 50-70% | 50-70% | 59.12% |
| Polyol | Pluracol P2010 | 30-50% | 30-50% | 38.22% |
| Surfactant | Dabco DC 193 | 0.1-2% | 0.5-1% | 1.00% |
| Fumed Silica | HDK H18 | 0-3.5% | 0-2% | 1.64% |
| Catalyst | Cotin 227 | 0-0.05% | 0-0.03% | 0.03% |

It should be appreciated that the exemplary trade name materials referenced are for illustration purposes only, and that suitable equivalent manufacturers may be employed. In addition, the A Side and B Side components may include other additives without departing from the scope of the present invention.

As noted above, the A Side and B Side components are preferably mixed by an applicator prior to being extruded or otherwise applied to the roofing substrate. During mixing, and after mixing, the A Side components and B Side components react to form a polyurethane adhesive composition having suitable physical properties. In a preferred embodiment, each of the A side and B side contain a dye of two separate colors which, upon mixing, creates a new color indicative of proper blending of the A and B sides. For example, the A side may contain a red dye and the B side may contain a white dye and upon mixing the composition has a pink color. It should be appreciated that other colors may be employed without departing from the scope of the present invention. The composition may be applied to substrates in environmental temperatures ranging from approximately 40 degrees Fahrenheit to approximately 100 degrees Fahrenheit.

The two-part adhesive composition exhibits the following characteristics: a cream time observed as approximately 10 to approximately 80 seconds, a final rise time observed as approximately 2 to approximately 3 minutes, a tack free time observed as approximately 7 to approximately 9 minutes, a lock down time observed as approximately 10 minutes, and a VOC content of 0 tested according to EPA Method 24 and SCAQMD Method 304-91.

In addition, the composition of the present invention was tested against equivalent products, the results of which are summarized below:

| | | RESULTS | | |
|---|---|---|---|---|
| | | | | “Green” |
| | TEST | Present | Non-green | Product from |
| PROPERTY | METHOD | Composition | equivalent | Competitor |
| Color | N/A | Yellow Tan | Yellow | Green |
| Green Content | Carbon 14 | 45% | N/A | 12.5% |
| Tensile Strength | ASTM D412* | 323 ± 22 psi | 277 ± 29 psi | — |
| Tensile Strength | ASTM D1623 | — | — | 39.27 psi |
| Peel Adhesion Concrete | ASTM D903 | 9.94 ± 3.64 | 15.42 ± 5.05 | 8.94 ± 3.60 |
| Peel Adhesion plywood | ASTM D903 | 12.79 ± 1.09 | 18.31 ± 6.66 | 16.91 ± 4.13 |
| Flexibility | ASTM D816 | Pass @ 70° F. | Pass @ 70° F. | Fail @ 70° F. |

*Modified

As shown above, the present composition exhibits comparable peel adhesion strength as well as superior tensile strength with a much higher green content. The tensile strength test method was based on ASTM D-412 wherein foam was shot on polyethylene sheet in several isolated beads. Before the foam was tack free, but after it had reached its maximum foam height, in other words, had finished foaming, the bead was compressed with a second polyethylene sheet. The foam was kept compressed for several hours to prevent the bead from curling on the edges. The samples were prepared following ASTM D-412. The testing procedure of ASTM D-142 was followed, except the speed of 10 inches per minute was used in place of the standard 20 inches per minute. The samples were tested after conditioning at room temperature for one week.

The description of the invention is merely exemplary in nature and variations that do not depart from the gist of the invention are intended to be within the scope of the invention. Such variations are not to be regarded as a departure from the spirit and scope of the invention.

1. A two-part adhesive for roofing applications, the two-part adhesive comprising:
a first composition comprising:
a renewable polyol present in an amount from about 15% to about 95% by weight of the first batch;
a surfactant or compatibilizer;
water; and
a catalyst,
wherein the first composition exhibits a shelf stability of more than six months; and
a second composition comprising:
an isocyanate;
a surfactant;
a rheology modifier; and
a polyol,
wherein the first composition is combined with the second composition to form a polyurethane adhesive.

2. The two-part adhesive of claim 1 wherein the renewable polyol is a non-petroleum based polyol.

3. The two-part adhesive of claim 1 wherein the renewable polyol is a soybean oil based polyol.

4. The two-part adhesive of claim 1 wherein the renewable polyol is one of a Castor oil based polyol and polyols based upon the hydroxylation of a fatty acid based triglyceride.

5. The two-part adhesive of claim 1 wherein the catalyst of the first composition includes a water stable catalyst selected to achieve a desired reaction profile between the first composition and the second composition when combined.

6. The two-part adhesive of claim 1 further comprising a second catalyst in the first composition, wherein the catalysts are selected from amine catalysts and are present in an amount from about 0.1% to about 4% by weight of the first composition.

7. The two-part adhesive of claim 1 wherein the surfactant or compatabilizer of the first composition is an ethylene oxide adduct of sodium lauryl sulfate present in an amount from about 0.1% to about 10% by weight of the first composition.

8. The two-part adhesive of claim 1 wherein the first composition further comprises a nonrenewable polyol present in an amount from about 0% to about 70% by weight of the first composition.

9. The two-part adhesive of claim 1 wherein the first composition further comprises a rheology modifier present in an amount from about 1% to about 3% by weight of the first composition.

10. The two-part adhesive of claim 1 wherein the rheology modifier is fumed silica.

11. The two-part adhesive of claim 1 wherein the first composition further comprises water present in an amount from about 0.5% to about 4.5% by weight of the first composition

12. The two-part adhesive of claim 1 wherein the first composition further comprises water present in an amount from about 0.5% to about 10% by weight of the first composition.

13. The two-part adhesive of claim 1 wherein the isocyanate is present in an amount from about 30% to about 100% by weight of the second composition.

14. The two-part adhesive of claim 1 wherein the polyol of the second composition includes any compound having at least one isocyanate-reactive functionality.

15. The two-part adhesive of claim 1 wherein the polyol of the second composition is polypropylene glycol present in an amount from about 30% to about 60% by weight of the second composition.

16. The two-part adhesive of claim 1 wherein the polyol of the second composition is polypropylene glycol present in an amount from about 0% to about 60% by weight of the second composition.

17. The two-part adhesive of claim 1 wherein the surfactant of the second composition is a silicone surfactant used to stabilize the foam of the adhesive composition and present in an amount from about 0.1% to about 2% by weight of the second composition.

18. The two-part adhesive of claim 1 wherein the rheology modifier of the second composition is fumed silica present in an amount from about 0.10% to about 4% by weight of the second composition.

19. The two-part adhesive of claim 1 wherein the catalyst of the second composition includes any metal based polyurethane catalyst employed to expedite the reaction of the polyol with the isocyanate, wherein the catalyst of the second composition is present in an amount from about 0.1% to about 0.5% by weight of the second composition.

20. A two-part adhesive comprising:
a first composition that exhibits a shelf stability of more than six months, the first composition comprising:
a renewable polyol present in an amount from about 90% to about 95% by weight of the first composition;
a surfactant or compatabilizer;
water; and
a catalyst; and
a second composition comprising:
an isocyanate;
wherein the first composition is combined with the second composition to form a polyurethane adhesive.

21. A method of preparing an adhesive comprising:
providing a first composition that exhibits a shelf stability of more than six months, the first composition comprising:
a non-petroleum based polyol present in an amount from about 15% to about 95% by weight of the first composition;
a surfactant or compatabilizer;
water; and
a catalyst;
providing a second composition comprising:
an isocyanate; and
a petroleum based polyol; and
combining the first composition and the second composition.

22. The two part adhesive of claim 1 wherein the renewable polyol is included in an amount of about 93% by weight of the first composition, the surfactant of the first composition is included in an amount of about 2.8% by weight of the first composition, the water is included in an amount of about 2% by weight of the first composition, the catalyst includes a first catalyst and a second catalyst each included in an amount of about 1.9% by weight of the first composition, the isocyanate is included in an amount of about 59% by weight of the second composition, the surfactant of the second composition is included in an amount of about 1% of the second composition, the rheology modifier is a fumed silica included in an amount of about 1.6% by weight of the second composition, and the polyol is included in an amount of about 38% by weight of the second composition.

23. The two part adhesive of claim 1 wherein the renewable polyol includes a first renewable polyol included in an amount of about 70% by weight of the first composition and a second renewable polyol included in an amount of about 23% by weight of the first composition, the surfactant of the first composition is included in an amount of about 2.8% by weight of the first composition, the water is included in an amount of about 2% by weight of the first composition, the catalyst includes a first catalyst and a second catalyst combined to be included in an amount of about 2.3% by weight of the first composition, the isocyanate is included in an amount of about 59% by weight of the second composition, the surfactant of the second composition is included in an amount of about 1% of the second composition, the rheology modifier is a fumed silica included in an amount of about 1.6% by weight of the second composition, and the polyol is included in an amount of about 38% by weight of the second composition.

24. The two part adhesive of claim 1 wherein the renewable polyol is included in an amount of about 94% by weight of the first composition, the surfactant of the first composition is included in an amount of about 1% by weight of the first composition, the water is included in an amount of about 2.2% by weight of the first composition, the catalyst is included in an amount of about 1.9% by weight of the first composition, the isocyanate is included in an amount of about 59% by weight of the second composition, the surfactant of the second composition is included in an amount of about 1% of the second composition, the rheology modifier is a fumed silica included in an amount of about 1.6% by weight of the second composition, and the polyol is included in an amount of about 38% by weight of the second composition.
